(19) United States
(12) Patent Application Publication
(10) Pub. No.: US 2015/0350819 A1
(43) Pub. Date: Dec. 3, 2015

(54) Bluetooth Transmission System

(71) Applicant: THLight Co., Ltd., Taipei City (TW)

(72) Inventors: Cheng-Jan CHI, Kaohsiung City (TW); Cho-Fu CHANG, New Taipei City (TW); Yu-Sheng WU, New Taipei City (TW); Tzu-Ho HUANG, Kaohsiung City (TW); Cheng-Wei LIN, Nantou County (TW); Cheng-Yu SHIH, New Taipei City (TW); Chin-Nan HUANG, New Taipei City (TW); Nien-An LAI, Taichung City (TW)

(21) Appl. No.: 14/725,311

(22) Filed: May 29, 2015

(30) Foreign Application Priority Data
Jun. 3, 2014 (TW) 103119289

(51) Int. Cl. H04W 4/00; H04W 76/02; H04W 8/00

(52) U.S. Cl. CPC H04W 4/008; H04W 8/005; H04W 76/023; H04W 76/04

(57) ABSTRACT

A Bluetooth transmission system is composed of at least a monitoring device and at least a mobile communication device. The monitoring device can detect and produce a biosignal, an environmental signal, and a broadcast signal, which are allocated with a universally unique identifier (UUID); further, the monitoring device has an information packet generation module that generates an information packet with the UUID, biosignal, environmental signal or broadcast signal, and then automatically sends the packet to a mobile communication device. In addition, when the mobile communication device receives information packet from different monitoring devices, it will decode the information packet, identify corresponding monitoring device through its UUID, and receive corresponding signal. Therefore, this invention can provide communication between at least a mobile communication device and several monitoring devices.

### BACKGROUND

1. Field of Invention

A Bluetooth transmission system; in particular, a Bluetooth transmissions system that employs Bluetooth Low Energy (BTLE) transmission technology to store and send information packets with Universally Unique Identifier (UUID).

2. Description of Prior Art

The popularization of mobile communication device, in conjunction with the availability of wireless transmission technology on mobile communication device with Bluetooth transmission technology, as well as the rapid development of sensor technology and detection of biosignal, all contribute to people's growing demand of immediate information. This is especially evident in the field of sports and fitness, healthcare, and security monitoring. Take healthcare for instance, many bio monitoring devices can send measured biosignals to smartphones through Bluetooth transmission technology, and this facilitates digital personal healthcare management, or allows medical personnel and family to get familiar with a patient's health conditions. For instance, ROC Patent No. M395457 entails a system and methodology that can transmit detected biosignals to an electronic device through Bluetooth module. Other precedent technologies are as follows:

(1) ROC Patent No. 1255704;

(2) PRC Patent No. CN203354532;

(3) US Patent No. US20090118595

However, the aforementioned Bluetooth transmission technology that transmits biosignals can only complete Paring Procedure between a biosignal monitoring device (such as a sphygmometer) and a mobile device, and come into effect when in Connected Procedure. When a user wants to receive biosignals from another biosignal monitoring device (such as body fat monitor), the paring procedure needs to be terminated, and re-start connection through Inquiry Procedure before transmission can begin. Therefore, the operating process is complicated and totally inconvenient. How to simply the operating process, as well to simultaneously receive and identify signals from different monitoring devices is an issue that remains to be resolved.

### SUMMARY OF THE INVENTION

In light of the aforementioned issues, this invention primarily aims to provide a Bluetooth transmission system that facilitates transmission with at least a monitoring device that uses UUID for identification. To achieve the intended objectives, this invention entails at least a monitoring device and at least a mobile communication device. The monitoring device is composed of a monitoring end processing module, a sensor module, an information packet generation module, and a monitoring end Bluetooth transceiver module. The monitoring end processing module is assigned an UUID; the sensor module senses and generates a sensor signal such as a biosignal from the user, an environmental signal from external environment, or a broadcast signal used for broadcasting; the information packet generation module generates an information packet that contains an UUID and encoded sensor signal; the monitoring end Bluetooth transceiver module automatically sends an information packet to at least a mobile communication device. Further, the mobile communication device has a mobile end Bluetooth transceiver module and an information packet decoding module; the mobile end Bluetooth transceiver receives information packet; the information packet decoding module decodes the packet and identifies corresponding monitoring device and receives biosignal, environmental signal or broadcast signal.

### DESCRIPTION OF THE DRAWINGS

FIG. 1 Diagram depicting system architecture of this invention

FIG. 2A Diagram depicting UUID of this invention (I)

FIG. 2B Diagram depicting UUID of this invention (II)

FIG. 3A Diagram depicting parameter of this invention (I)

FIG. 3B Diagram depicting parameter of this invention (II)

FIG. 3C Diagram depicting parameter of this invention (III)

FIG. 4A Diagram depicting implementation of this invention (I)

FIG. 4B Diagram depicting implementation of this invention (II)

FIG. 5 Diagram depicting implementation of this invention

FIG. 6 Diagram depicting another system architecture (I) of this invention

FIG. 7 Diagram depicting another system architecture (II) of this invention

FIG. 8 Diagram depicting another system architecture (III) of this invention

FIG. 9 Diagram depicting parameters of another system architecture (III) of this invention

FIG. 10 Diagram depicting another system architecture (IV) of this invention

### DETAILED DESCRIPTION

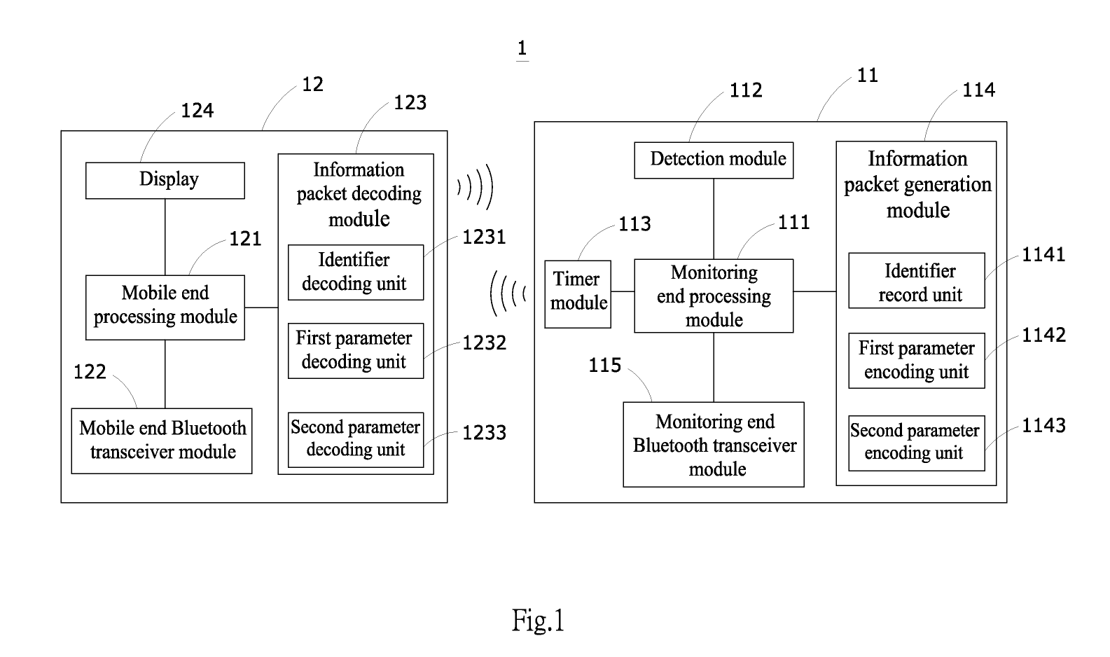

Please refer to FIG. 1. The Bluetooth transmission system 1 primarily includes at least a monitoring device 11, and at least a mobile communication device 12. This figure is an example with a monitoring device 11 and a mobile communication device 12. Monitoring device 11 can be a bio monitoring device, environmental monitoring device or broadcast monitoring device, as well as any other monitoring device with monitoring functions. Monitoring device 11 has a monitoring end processing module 111, a detection module 112, a timer module 113, an information packet generation module 114, and a monitoring end Bluetooth transceiver module 115, which shares information links with said monitoring end processing module 111 separately. In particular:

Monitoring end processing module 111 can be a microcontroller, microprocessor, or a CPU; each monitoring end processing module 111 is assigned a Universally Unique Identifier (UUID) that can serve as differentiation information for monitoring device 11;

Detection module 112 is utilized for detection purposes and to generate a detection signal. When monitoring device is a bio monitoring device such as sphygmometer, glucometer, and thermometer or body fat monitor, the detection module 112 will detect at least one bio indicators (such as blood pressure, glucose level, oxygen level, body temperature, pulse, body fat ratio, weight, cholesterol, uric acid, etc.) and produce a corresponding biosignal. When monitoring device 11 is an environmental detection device such as light sensor, carbon monoxide meter, door security sensor and electronic monitoring device, the detection module 112 will detect at least one environmental indicator of the external environment (such as brightness, gas concentration, door status, appliance failure signals, etc.), and produce a corresponding environmental signal. When monitoring device 11 is a broadcast detection device, the detection module 112 will detect at least a broadcast signal sent by detection broadcast device (such as special offers, free gifts, etc.), and produce a corresponding broadcast signal. The aforementioned monitoring device 11 can be but not limited to worn (portable) versions;

Timer module 113 is utilized to record a detection time of the detection signal generated by detection module 112. Timer module 113 can be pre-programmed for different time frame such as seconds, minutes, hours, days, months or years;

Information packet generation module 114 encodes the UUID of monitoring device 11, detection signals (such as biosignal, environmental signal, or broadcast signal) from detection module 112, and detection time recorded of timer module 113, and pack all of the above into an information packet;

Monitoring end Bluetooth transceiver module 115 can send information packet generated by information packet generation module 114 through Bluetooth 4.0 (also known as BTLE—Bluetooth Low Energy) in our implementation instance. However, any Bluetooth transmission technology that facilitates transmission of at least one information packet to multiple mobile communication devices 12 should be considered an embodiment of monitoring end Bluetooth transmission module 115, and not construed as limiting.

As described, please refer again to FIG. 1. Mobile communication device 12 can refer to smartphone, tablet, or notebook. Said mobile communication device 12 includes a mobile end processing module 121, a mobile end Bluetooth transceiver module 122, an information packet decoding module 123, and display 124; the said mobile end Bluetooth transceiver module 122, information packet decoding module 123, and display 124 share information links with said mobile end processing module 121 seperately. Mobile end processing module 121 can be a microcontroller, microprocessor, CPU, etc. Mobile end Bluetooth transceiver 122 receives information packet from said monitoring end Bluetooth transceiver module 115 trough Bluetooth transmission technology. Information packet decoding module 123 stores at least a comparison table that facilitates information packet decoding module 123 in the decryption of information packets. Said monitoring device 11 is detected through a UUID in its information packet, which provides biosignal, environmental signal or broadcast signal generated by detection module 112 of monitoring device 11, as well as detection time recorded by timer module 113. Lastly, the above information is presented in display 124 of mobile communication device 12; the aforementioned comparison table refers to the representative meaning of UUID, first parameter, and second parameter. Its values can be stored within information packet decoding module 123, and be updated thereafter.

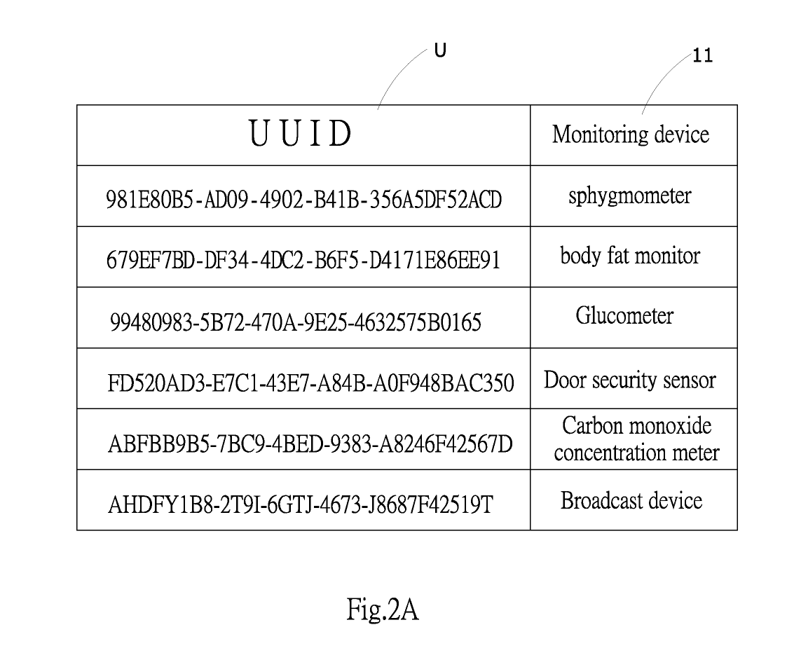

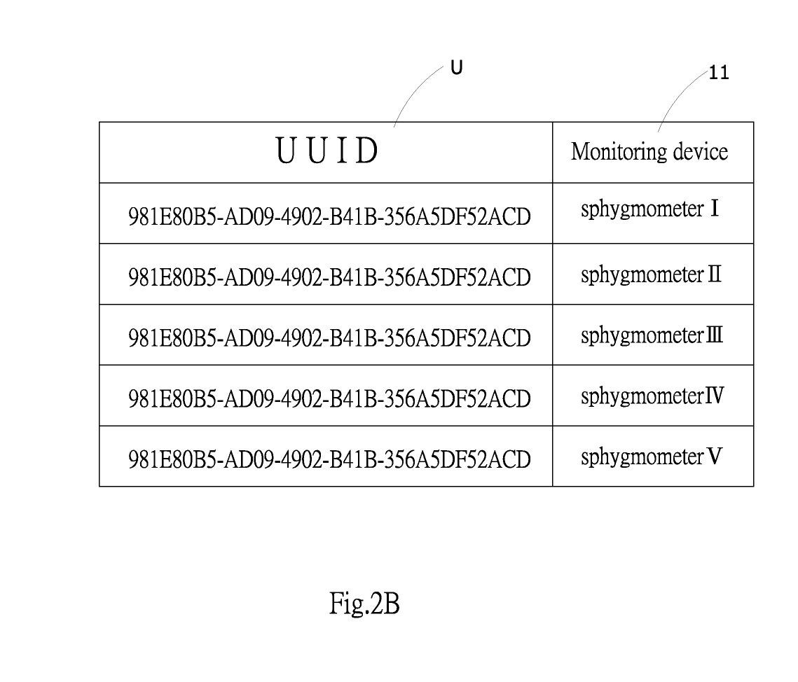

In the same line of thought, please refer to FIG. 2. Monitoring end processing module 111 of every monitoring device 11 is assigned a UUID U, which consists of 32 hexadecimal numbers. The serial code is divided into five segments, and is represented with 32 bits in 8-4-4-4-12 format. In a better implementation instance, different monitoring device 11 has their own UUID (shown in FIG. 2). However, please refer to FIG. 2B, which deliberately re-uses UUID U to represent similar device. In other words, monitoring device 11 under the sphygmometer category could share the same UUID U; identifier record unit 1141 of the information packet generation module 114 of monitoring device 11 is utilized to record UUID U of monitoring device 11; an identifier decoding unit 1231 of information packet decoding module 123 of the mobile communication device 12 utilizes UUID U to distinguish monitoring device 11, for instance “981E80B5-AD09-4902-B41B-356A5DF52ACD” refers to sphygmometer, and “FD520AD3-E7C1-43E7-A84B-A0F948BAC350” refers to door security sensor.

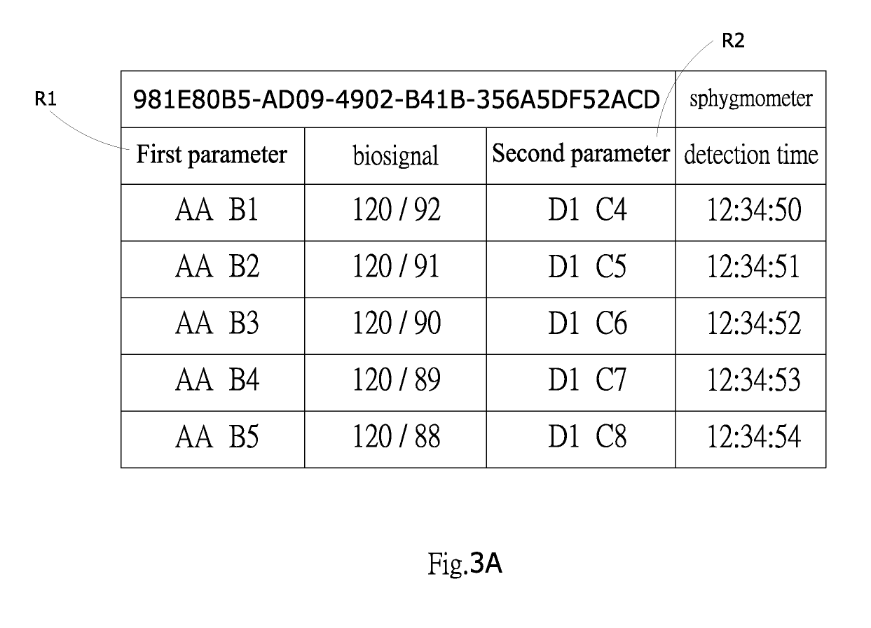

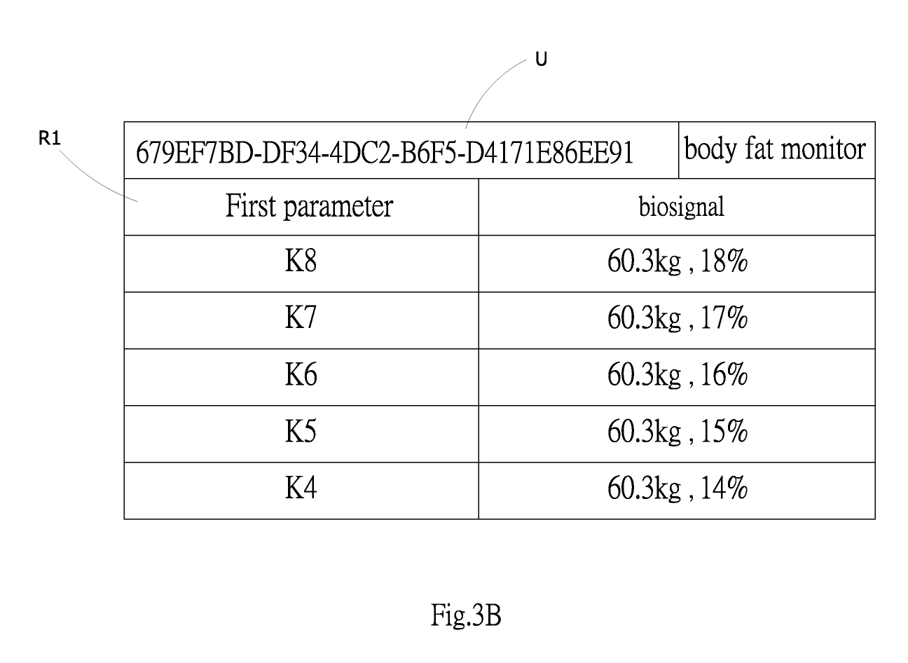

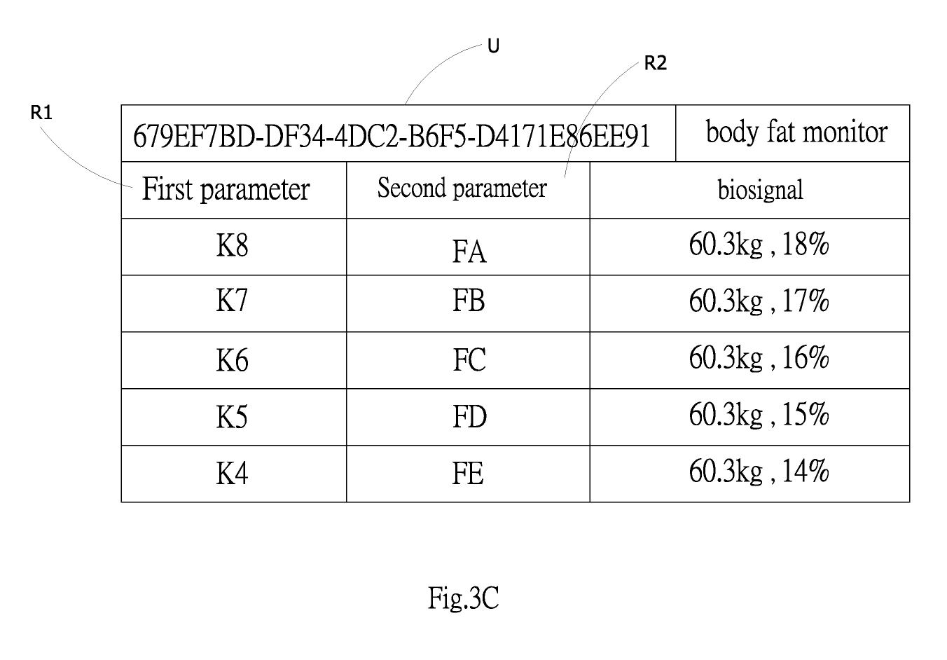

Please refer to FIG. 3A. Information packet generation module 114 of monitoring device 11 will encode biosignal, environmental signal, broadcast signal of detection module 112, as well as record detection time of timer module 113. Take for instance a biosignal and detection time; a first parameter encoding unit 1142 of information packet generation module 114 will encode biosignal to obtain a first parameter R1; a second parameter encoding unit 1143 will encode detection time to obtain a second parameter R2; take a monitoring device 11 for instance, “981E80B5-AD09-4902-B41B-356A5DF52ACD” represents a sphygmometer, and when its biosignal (blood pressure value) is “120/90”, a first parameter R1 will be encoded as “AA B3”; when the biosignal detection time is “12:34:54”, a second parameter R2 will be encoded as “D1 C8”; the first parameter R1 and second parameter R2 are not limited to 4-character encoding method as shown; it could also include at least one hexadecimal digit in the encoding.

Please refer to FIG. 3B. The information packet generated by information packet generation module 114 can only contain one UUID U and first parameter R1; take a monitoring device 11 for instance, “679EF7BD-DF34-4DC2-B6F5-D4171E86EE91” represents a body fat monitor, and “K6” as represented by first parameter R1 could refer to a biosignal with “60.3 kg, 16%” value; therefore, identifier decoding unit 1231 of information packet decoding module 123 of mobile communication device 12 identifies monitoring device 11 through a UUID U, after which, first parameter R1 and second parameter R2 can be decrypted using comparison table with a first parameter decoding unit 1232 and a second parameter decoding unit 1233 of the information packet decoding module 123; the corresponding meanings (either biosignal or environmental signal) are obtained; the content of the information packet can be either its UUID U, first parameter R1 or second parameter R2, or any combination thereof.

Please refer to FIG. 3C. The information packet generated by information packet generation module 114 consists of UUID U, first parameter R1, and second parameter R2. However, R1 and R2 can be combined in their encoding to represent one meaning. Take another monitoring device 11 for instance, as represented by “679EF7BD-DF34-4DC2-B6F5-D4171E86EE91” as a body fat monitor, the first parameter K6 and second parameter FC could be combined and set as a biosignal with “60.3 kg, 16%” value. Therefore, the meaning and encryption method for first parameter R1 and second parameter R2 could be pre-determined by the system administrator of Bluetooth transmission system 1, or updated thereafter.

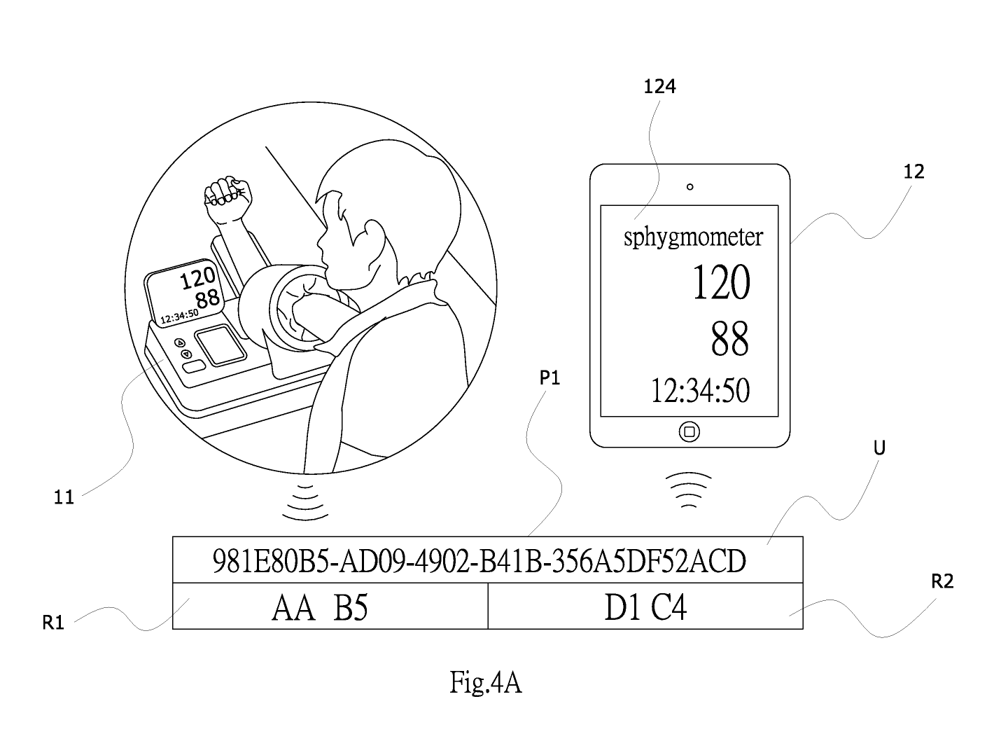

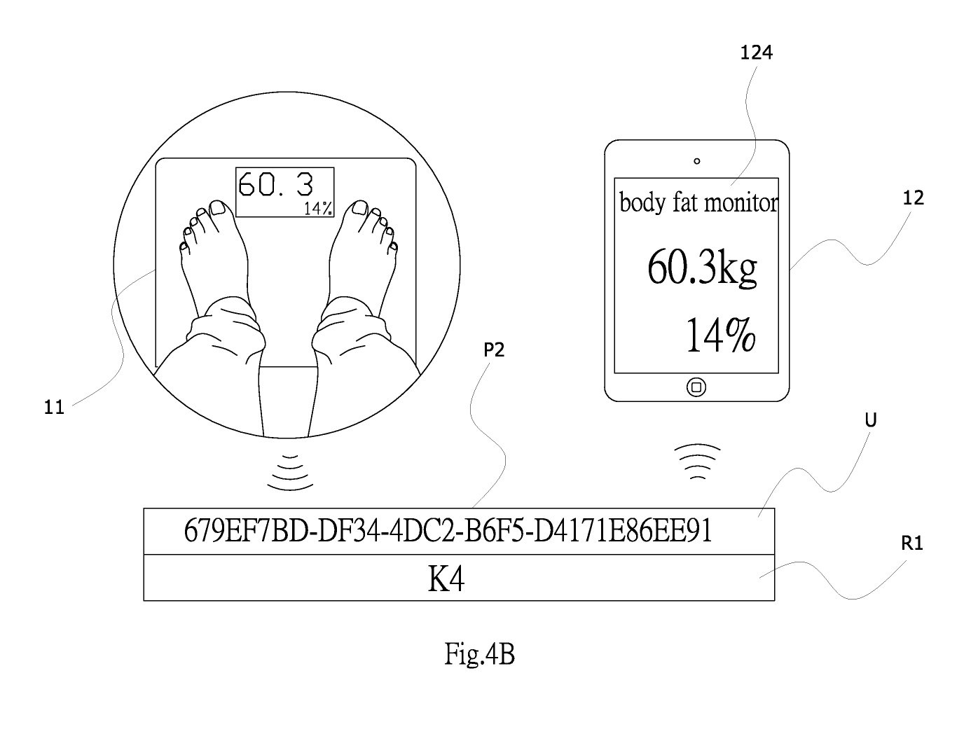

Please refer to FIG. 4A. When a user measures his blood pressure at his home utilizing monitoring device 11 (such as a sphygmometer) at 12:34:50 and obtains a blood pressure value “120/88”, identifier record unit 1141 of information packet generation module 114 of monitoring device 11 will record UUID U of the mentoring device 11 as “981E80B5-AD09-4902-B41B-356A5DF52ACD”. First parameter encoding unit 1142 of information packet generation module 114 will encode “120/88” blood pressure value and obtain “AA B5” for first parameter R1. Second parameter encoding unit 1143 of information packet generation module 114 will encode “12:34:50” detection time and obtain “D1 C4” for second parameter R2 (FIG. 3). Lastly, an information packet P1 that contains UUID U, first parameter R1, and second parameter R2 will automatically send information packet P1 to mobile communication device 12 through monitoring end Bluetooth transceiver module 115 of monitoring device 11. Mobile end Bluetooth transceiver module 122 of mobile communication device 12 will receive information packet P1 and identifies monitoring device 11 with UUID U of “981E80B5-AD09-4902-B41B-356A5DF52ACD” as sphygmometer (such as FIG. 2A) by identifier decoding unit 1231 of information packet decoding module 123. First parameter decoding unit 1232 will decrypt first parameter R1 to obtain blood pressure value of “120/88”; second parameter decoding unit 1233 will decrypt second parameter R2 to obtain detection time of the blood pressure value at “12:34:50” (12:34 pm and 50 seconds). Finally, display 124 of mobile communication device 12 will display values of name, biosignal, and other contents (such as sphygmometer, blood pressure value and detection time) of monitoring device 11.

In the same line of thought, please refer to FIG. 4B. When the user completes measuring blood pressure, and continues to use another monitoring device 11 (such as body fat monitor scale) within the same space. After determining the body weight and fat ratio as “60.3 kg, 14%”, information packet generation module 114 of monitoring device 11 will generate an information packet P2 with UUID U and first parameter R1; through monitoring end Bluetooth transceiver module 115 of monitoring device 11, information packet P2 is automatically sent to mobile communication device 12; mobile end Bluetooth transceiver module 122 of mobile communication device 12 receives information packet P2 and decodes P2 with information packet decoding module 123 to determine monitoring device 11 and receive corresponding detection signal (please refer to FIG. 3B). Therefore, the Bluetooth transmission system 1 of this invention can directly facilitate users to communicate with several monitoring devices 11, thereby improving prior art. When one desires to utilize Bluetooth transmission with other devices, a complex “Search-Pair-Connect” operating procedure is needed.

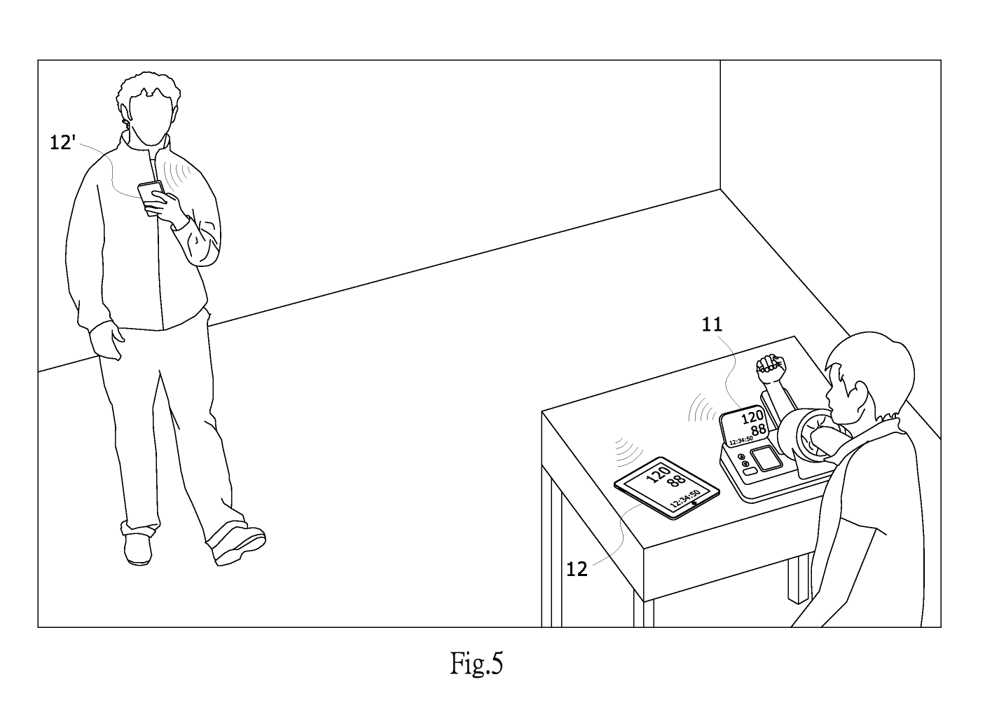

In the same line of thought, please refer to FIG. 5. The Bluetooth transmission 1 of this invention facilitates communication between at least a mobile communication device 12 with several monitoring devices 11; further, it allows communication between at least a monitoring device 11 with several mobile communication devices (12, 12′). When the user completes blood pressure measurement with sphygmometer, information packet generation module 114 of monitoring device 11 will generate an information packet (not shown in diagram), and automatically send information packet to several mobile communication devices (12, 12′) through monitoring end Bluetooth transceiver module 115. Therefore, Bluetooth transmission system 1 can be employed at home environment and medical care environment, for instance, the blood pressure value of a patient under care can be accessed simultaneously by several caretakers, or the children of a household can simultaneously learn about their father's weight and body fat ratio.

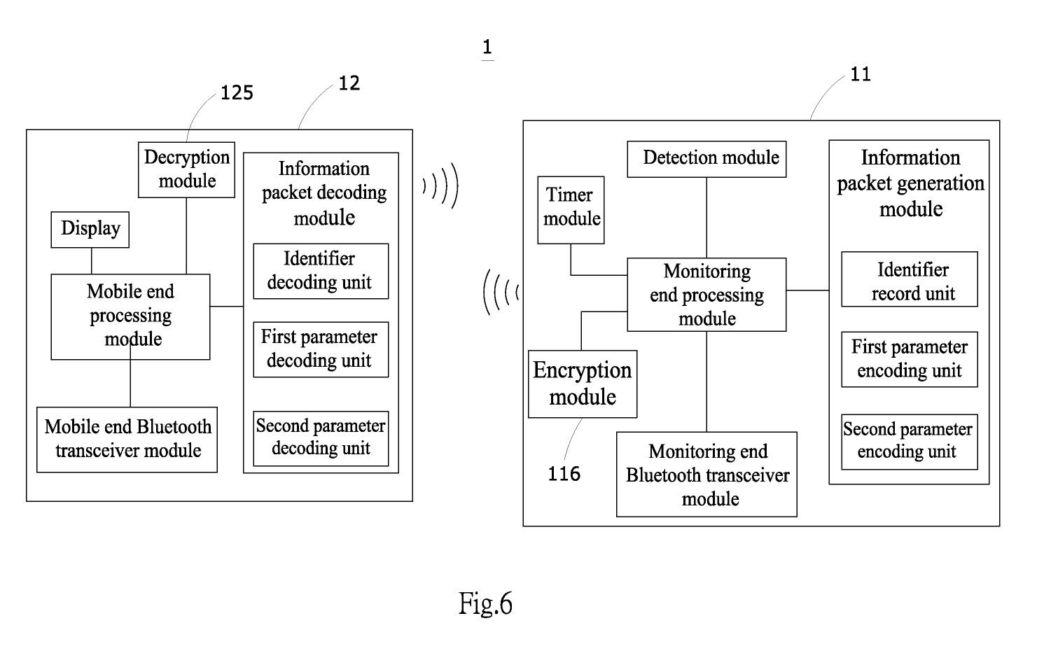

In the same line of thought, please refer to FIG. 6. Detection signal as measured by monitoring device 11 (either biosignal or environmental signal) can be private information. Monitoring device 11 of the Bluetooth transmission system 1 can add another encryption module 116. Encryption module 116 shares information links with monitoring end processing module 111. When information packet is generated by information packet generation module 114 of monitoring device 11 (not shown in diagram), the encryption module 116 can encrypt the information packet. Mobile communication device 12 can include a decryption module 125; decryption module 125 shares information links with mobile end processing module 121. When mobile end Bluetooth transceiver module 122 of mobile communication device 12 receives encrypted information packet from monitoring end Bluetooth transceiver module 115, it needs decryption module 125 to decrypt said information packet; only then can information packet decoding module 123 of mobile communication device 12 decodes the information packet. The function serves to protect privacy, and the aforementioned encryption and decryption methods can be one to one key certificate methods employed in prior art.

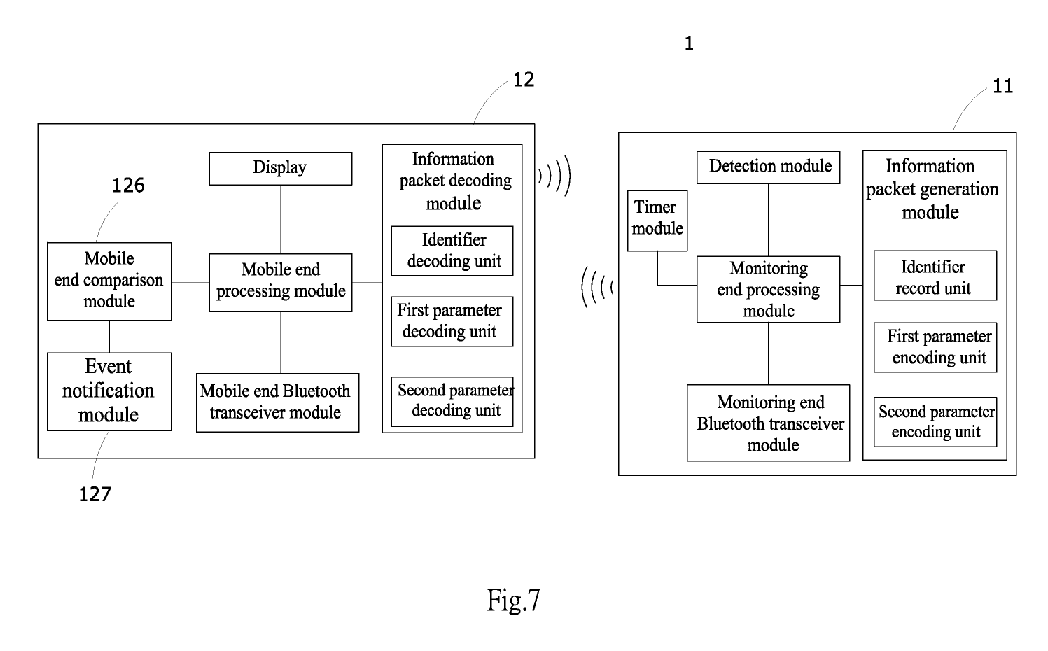

Using the same line of thought, please refer to FIG. 7. Mobile communication device 12 of Bluetooth transmission system 1 includes a mobile end comparison module 126. Mobile end comparison module 126 shares information links with mobile end processing module 121, and facilitates comparison of generated biosignal or environmental signal from information packet decoding module 123 with a standard biosignal or a standard environmental signal, for instance blood pressure value of “140/90” is compared with standard blood pressure value of “120/80”. Mobile communication device 12 includes an event notification module 127, which shares information links with mobile end comparison module 126. When mobile end comparison module 126 finishes comparison and generate anomalies, such as high blood pressure value of “140/90”, an event notification (not shown in diagram) will be sent by event notification module 127. The said event notification can be but not limited to a SMS or phone call to designated contact, medical personnel or security personnel, or it could be a sound effect to notify the user.

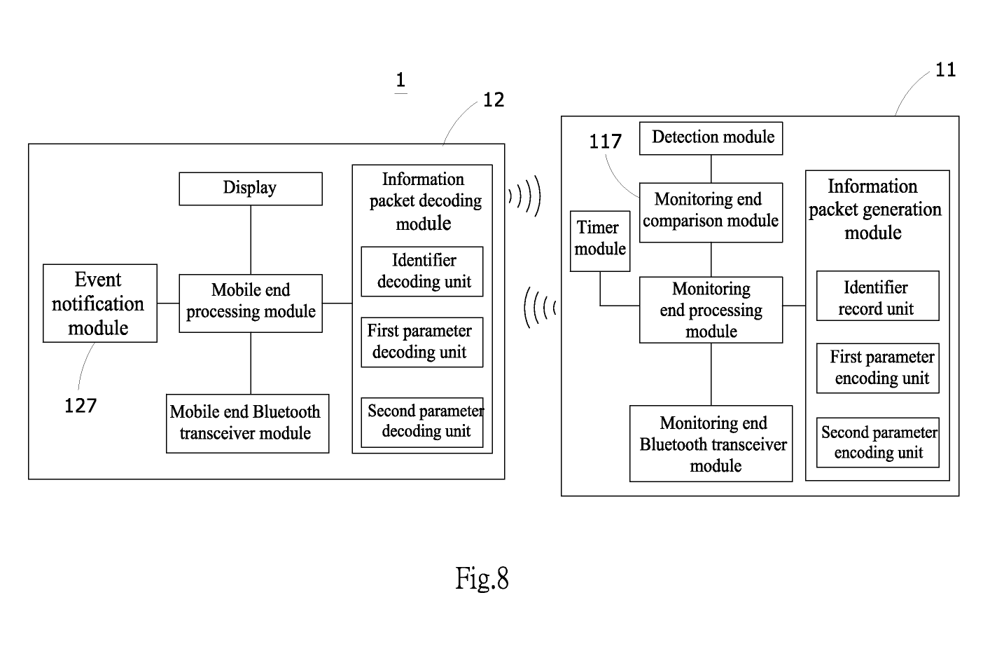

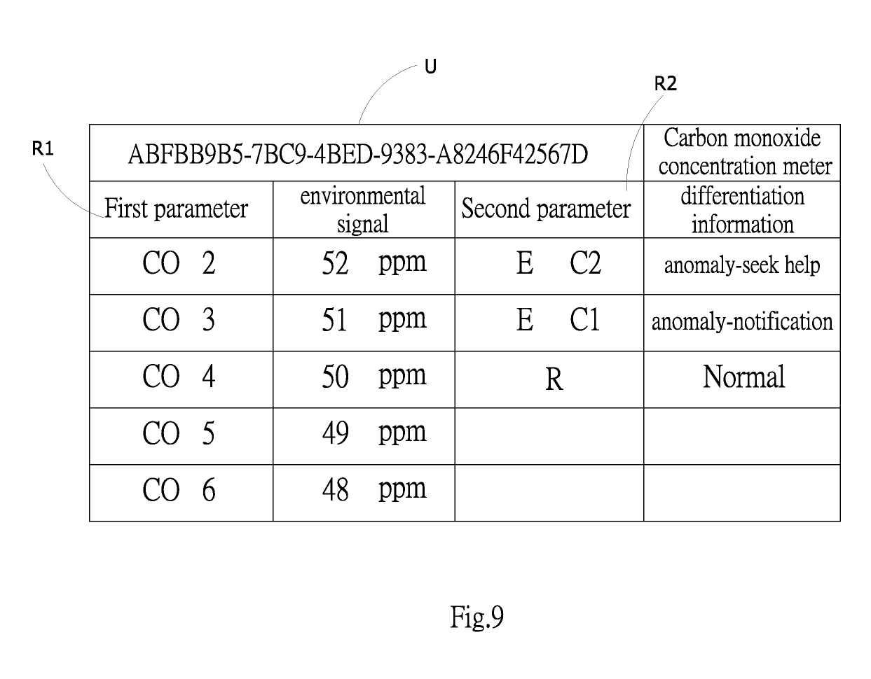

Following similar line of thought, please refer to FIG. 8. Comparison module 126 can also be installed in monitoring device 11, and shares information links with monitoring end processing module 111 and detection module 112. When detection module 112 of monitoring device 11 detects and generates detection signal, monitoring end comparison module 126 will compare the said signal with a standard detection signal, and then information packet generation module 114 will encode it to generate an information packet; please refer to FIG. 9, the diagram uses the example of carbon monoxide concentration meter; detection module 112 detects a carbon monoxide concentration in the environment, and generates a “52 ppm” environmental signal; the comparison module 126 then compares it (52 ppm) with a standard environmental signal (for instance, normal CO concentration should be less than 50 ppm). A differentiation information will be generated after comparison, for instance when a CO concentration of 52 ppm is greater than a standard CO concentration of 50 ppm. However, an anomaly notification differentiation information will be generated if it is still within acceptable range (±3 ppm). In addition to recording UUID U of monitoring device 11, first parameter encoding unit 1142 of the information packet generation module 114 encodes “52 ppm” into environmental signal “CO2” of the first parameter R1; further, second parameter encoding unit 1143 encodes “anomaly notification” into differentiation information “E C1” of the second parameter R2. Lastly, it generates an information packet that contains UUID U, first parameter R1, and second parameter R2; the packet is then sent to at least one mobile communication device 12 through monitoring end Bluetooth transceiver module 115. In addition, mobile communication device 12 has an event notification module 127, which shares information link with mobile end processing unit 121. When information packet decoding unit 123 decodes said information packet, in addition to identifying monitoring device 11 as a CO concentration meter and receiving environmental signal as a CO concentration level of 50 ppm, the second parameter decoding unit 1233 decodes second parameter R2 and receives “anomaly notification” differentiation information. At this moment, event notification module 127 automatically sends an event notification (not shown in diagram); the types and generation conditions of the differentiation information of this implementation instance, as well as encoding method for first parameter R1 and second parameter R2 are just an ideal implementation instance, and should not be considered as a definite condition.

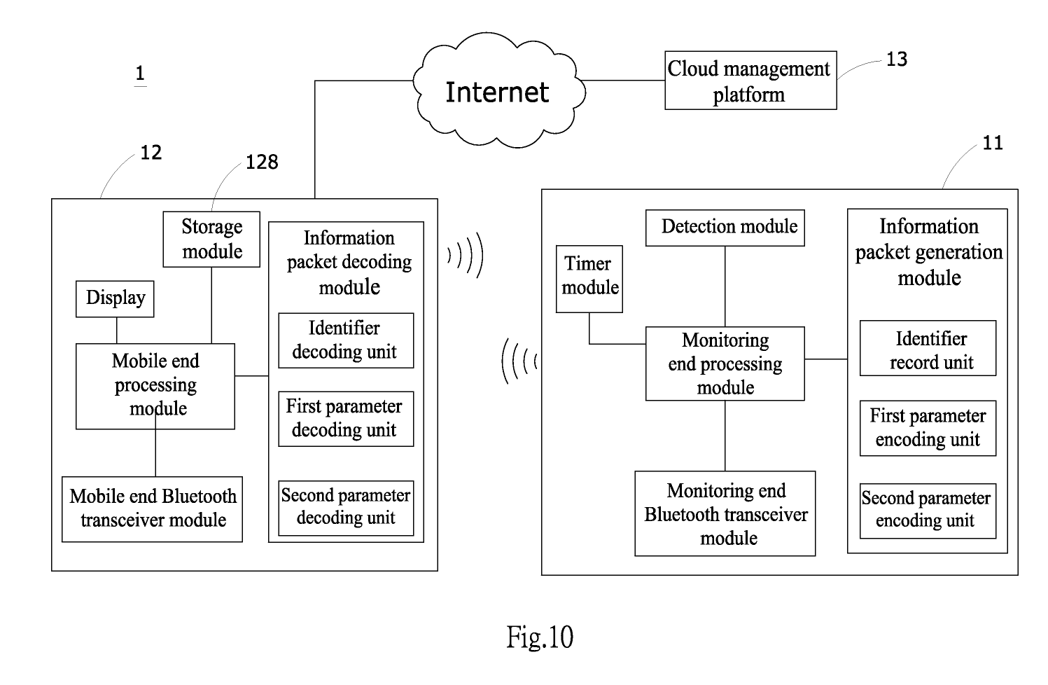

Using the same line of reasoning, please refer to FIG. 10. Mobile communication device 12 of Bluetooth transmission system 1 includes a storage module 128, which shares information links with mobile end processing module 121. Storage module 128 can be RAM that facilitates storage of data such as biosignal and environmental signal of detection device 11. Mobile communication device 11 can send aforementioned data to a cloud management platform 13 through wireless transmission technology, thereby providing a more comprehensive and professional health record management and security record management.

Synthesizing the above, we know that by implementing this invention, it can indeed achieve the purpose of utilizing a Bluetooth transmission system to facilitate communication with at least one monitoring device through UUID identification.

As such, the aforementioned examples are merely an implementation instance of this invention and is not intended to limit the range of application of this invention; any changes or modification of aforementioned application that aligns with the spirit or scope of this invention by any skilled applicants should be consider as within the scope of this invention.

1. A Bluetooth transmission system that includes:
At least a monitoring device, and said monitoring device includes a monitoring end processing module, as well as a detection module, an information packet generation module, and a monitoring end Bluetooth transceiver module; the above modules share information links with said monitoring end processing module; said monitoring end processing module includes a UUID; said detection module detects and generates a detection signal; said information packet generation module encrypts said detection signal, and combines it with said UUID to form an information packet;
At least a mobile communication device, which includes a mobile end processing module, as well as an information packet decoding module and a mobile end Bluetooth transceiver module; the above modules share information links with said mobile end processing unit; and
Said mobile end Bluetooth transceiver module receives said information packet sent by said monitoring end Bluetooth transceiver module; said information packet decoding module decrypts said information packet and identifies said monitoring device and said detection signal.

2. Whereas the Bluetooth transmission system as described in claim 1; in particular, said information packet generation module includes an identifier record unit; said identifier record unit records said UUID

3. Whereas the Bluetooth transmission system as described in claim 1; in particular, said monitoring device includes a timer module, and shares information links with said monitoring end processing module; said timer module records a detection time of said detection signal.

4. Whereas the Bluetooth transmission system as described in claim 3; in particular, said information packet generation module consists of a first parameter encoding unit, and a second parameter encoding unit. Said first parameter encoding unit and said second parameter encoding unit will encrypt said detection signal and said detection time in order to generate a first parameter and a second parameter.

5. Whereas the Bluetooth transmission system as described in claim 4; in particular, said first parameter is said detection signal or said detection time, or any combination thereof; said second parameter is said detection signal or said detection time, or any combination thereof.

6. Whereas the Bluetooth transmission system as described in claim 4; in particular, said information packet includes said UUID, said first parameter, and said second parameter, or any combination thereof.

7. Whereas the Bluetooth transmission system as described in claim 4; in particular, said information packet decoding module stores a comparison table, which has an identification decryption unit, a first parameter decoding unit, and a second parameter decoding unit; said identifier decoding unit will identify said monitoring device based on decrypting UUID with a comparison table; said first parameter decoding unit will decrypt first parameter based on said comparison table; said second parameter decoding unit will decrypt second parameter based on said comparison table.

8. Whereas the Bluetooth transmission system as described in claim 1; in particular, said detection signal consists of one or any combination of the following: a biosignal, an environmental signal, and a broadcast signal.

9. Whereas the Bluetooth transmission system as described in claim 1; in particular, said monitoring device includes an encryption module, and shares information links with said monitoring end processing module; said encryption module encrypts said information packet. Said mobile communication device includes a decryption module, and share information links with said mobile end processing module; when said decryption module decrypts said information packet, said information packet decoding module begins decryption on said information packet.

10. Whereas the Bluetooth transmission system as described in claim 1; in particular, said mobile communication device includes a mobile end comparison module and an event notification module; said mobile end comparison module and said mobile end processing module share information links; said event notification module and said mobile end comparison module share information links; said mobile end comparison module compares said detection signal with a standard detection signal, and if there any anomalies, said event notification module will send an event notification.

11. Whereas the Bluetooth transmission system as described in claim 1; in particular, said monitoring device includes a monitoring end comparison module; the said monitoring end comparison module and said detection module and said monitoring end processing module share information links; said monitoring end comparison module compares said detection signal with a standard detection signal to generate a differentiation information; said information packet generation module lists said detection signal and said differentiation information, and packets it with the said UUID to form the said information packet.

12. Whereas the Bluetooth transmission system as described in claim 11; in particular, said mobile communication device includes an event notification module, and the said event notification module and the said mobile end processing module share information links; the said information packet decoding module decrypts said information packet in order to obtain said differentiation information, and the said event notification module will send an event notification in accordance with said differentiation information.
